(19) United States
(12) Patent Application Publication
(10) Pub. No.: US 2006/0031839 A1
(43) Pub. Date: Feb. 9, 2006

(54) Data processing apparatus and method of synchronizing at least two processing means in a data processing apparatus

(75) Inventor: I-Chih Kang, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninkljke Philips Eletronics N.V., Eindhoven (DE)

(21) Appl. No.: 10/531,154

(22) PCT Filed: Sep. 12, 2003
(86) PCT No.: PCT/IB03/04041

§ 371 Date: Apr. 12, 2005

(30) Foreign Application Priority Data
Oct. 15, 2002 (EP) 02079296.6

(51) Int. Cl. G06F 9/46

(52) U.S. Cl. 718/102

(57) ABSTRACT

The present invention provides a data processing apparatus and a method of synchronizing at least two processing means in such a data processing apparatus which allow multiple readers to share the same queue. No locks or special instructions are needed to simultaneously access the queue administration information by multiple readers. No data is copied during the writing process. Furthermore, the present invention allows the application to dynamically reconfigure the single-writer multiple-reader queue, for instance to add or remove readers at run-time. This is achieved according to the invention by providing a branch record means comprising a primary branch record for a primary branch between a producer task and a first consumer task and secondary branch records for secondary branches between said producer task and further consumer tasks, said branch records storing appointed to the same location of the memory means and a reference to the next branch so as to obtain a linked list of branch records.

The present invention relates to a data processing apparatus comprising

at least one processing means being capable of providing data for further processing by the same or other processing means,

a queue structure comprising at least two branches between a producer task performed by a first processing means and a number of consumer tasks executed by at least a second processing means,

a memory means for storing data to be accessed by said consumer tasks, said memory means being shared between said at least two branches. Further, the present invention relates to a method of synchronizing at least two processing means in a data processing apparatus, at least one of which being capable of providing data for further processing by other processing means, said method comprising the steps of:

defining a queue structure comprising at least two branches between a producer task performed by a first processing means and consumer tasks executed by at least a second processing means,

sharing a memory means for storing data to be accessed by said consumer tasks between said at least two branches.

Presently many implementations exist for circular queues. These queues serve as communication buffers required in highly parallel processing systems. Such queues are usually mapped on a storage medium, such as shared memory. The administrative information of such queues often consists of some reader and writer pointers referring to the address locations of the elements of the queue in the memory and some other information relating to the fullness of the queue. Several mechanisms then exist to make sure that the reader and the writer of the queue are synchronized, i.e. the reader cannot read from an empty queue and the writer cannot write to the queue when it is full. However, most proposed queue structures and administrating and synchronization mechanisms are for queues having only a single writer and a single reader. Not many solutions exist for single-writer multiple-reader queues.

If a certain producer of data has multiple consumers, one option is to construct separate queues (one for each consumer) and for the producer to copy its data into the queues. However, this copying is undesired, since this leads to more memory and bandwidth usage. Another option is stick to one single copy of the queue data and to extend the queue structure to keep track of the progress of the different readers of the queue. In U.S. Pat. No. 6,304,924 a single-writer multiple-reader version of a queue structure is disclosed, where the queue has multiple read pointers and associated readers and one single write pointer and associated writer. Furthermore, the direction of the read pointer (forward or reverse) is also duplicated per reader. The problem with this structure is that the number of readers is fixed, i.e. when the single-writer multiple-reader queue is instantiated, the number of readers and the number of copies of the read pointer and direction are known and fixed. However, more and more complex applications are emerging requiring more flexibility from the circular queues, for instance being able to dynamically add or remove readers. This is not possible with the known queue structure.

Having an extended version of the basic queue structure does therefore not offer the flexibility needed for future applications. One option to solve the aforementioned problem of the fixed number of readers is to store administration fields in the queue structure for a maximum number of possible readers in a linear array, for example the read pointers, and then add a counter to indicate the actual number of readers. This option has the disadvantage that this maximum has to be chosen rather conservatively, so the queue structure takes up more memory space than absolutely needed when the actual number of readers during run-time is lower than this maximum. Moreover, dynamically adding a reader is simple this way, but removing a reader takes quite some effort. In this case, first the reader to be removed has to be identified in the array by doing a linear search. Next, the elements in the array behind this location have to be moved one place forward. Finally, the reader counter can be decremented.

It is therefore an object of the present invention to provide a data processing apparatus which offers more flexibility and simpler handling, in particular with regard to the addition and removal of readers to the circular queue structure. Furthermore, a corresponding flexible and simpler method of synchronizing at least two processing means in a data processing apparatus shall be provided.

These objects are achieved according to the present invention by a data processing apparatus as described above, further comprising

a branch record means comprising a primary branch record for a primary branch between said producer task and a first consumer task and secondary branch records for secondary branches between said producer task and further consumer tasks, said branch records storing a pointer to the same location of said memory means and a reference to the next branch so as to obtain a linked list of branch records.

These objects are also achieved according to the present invention by a method as described above, further comprising the step of

defining a branch record means comprising a primary branch record for a primary branch between said producer task and a first consumer task and secondary branch records for secondary branches between said producer task and further consumer tasks, said branch records storing a pointer to the same location of said memory means and a reference to the next branch so as to obtain a linked list of branch records.

The present invention is based on the idea to represent a single-writer multiple-reader circular queue as a collection of branches. If a producer task communicates the same data to several consumer tasks, the data is not copied several times in the process for each consumer task. The producer task accesses the structure of the primary branch, which is the initially created queue for communicating with the primary consumer. This is also the structure accessed by the primary consumer task. The secondary branches, connecting to further secondary consumer tasks, are created afterwards and are accessed by these consumers tasks only. In this way, the producer task is unaware of the number of consumer tasks, and the consumer tasks have no knowledge of each other.

Contrary to the above described known solutions, where a consumer task needs to identify itself when accessing the queue, since otherwise the queue does not know which read pointer and direction in the array belongs to this particular consumer task, having separate queue structures for each consumer tasks assures that each can access the queue as if it is the only reader of the queue. In this way the queue structure and access mechanism can be kept generic regardless of whether it is single- or multi-reader. Furthermore, since each consumer sees its own copy of the queue structure, no locks or special protection mechanisms are necessary to protect any shared data.

According to the present invention the queue structures are duplicated as more consumer tasks are added to the queue. However, all their read and write pointers refer to the same locations in memory, hence no copying of data is needed.

Since according to the present invention each branch has a separate queue structure, a mechanism is required to link the queue structures to form a single-writer multiple-reader queue structure. For this purpose, the branch record means comprising a primary and secondary branch records is defined, each branch record having a “nextbranch” field, which is a reference or pointer to the next secondary branch. A linked list of branches is thus obtained.

Readers can now be added to the queue by adding a branch to the primary branch. The linked list is traversed until the tail is reached, then the new branch queue structure is appended to the linked list, as proposed in claim 10. In this way, a potentially unlimited number of readers can be added.

Preferred embodiments of the invention are defined in the dependent claims. To be able to dynamically remove readers or branches, respectively, from the single-writer multiple-reader queue, one option is to start from the primary branch and traversing the list again, each time examining the branch structure pointer. When the to be removed branch is encountered, the list is simply updated by replacing the “nextbranch” field of the predecessor branch by the reference to the successor branch. However, if it shall be possible to remove the branch directly as if it is a normal queue (single-writer single-reader) without traversing the list, then also a “prevbranch” field is required in the queue structure, indicating the previous branch in the list, as proposed according to the preferred embodiment of claim 2. Hence a double linked list of branches is obtained.

When removing a certain branch, the list can be updated by looking up the previous branch and replacing the “nextbranch” field by the successor branch of the removed branch, and looking up the next branch and replacing its “prevbranch” field by the predecessor branch of the removed branch as proposed according to the preferred embodiment of claim 11. A preferred embodiment for removing the primary branch from the queue structure is defined in claim 12.

Preferred embodiments of the data processing apparatus using either a writer pointer and reader pointers or a writer counter and reader counters for denoting the producer task's and the producer tasks' position in the queue are defined in claims 3 and 4.

Preferred embodiments of the method of synchronizing at least two processing means describing the writing of data items in the queue by the producer task and the reading of data items from the queue by a particular consumer task and the effects thereof on the pointers or counters, respectively, and on the queue fullness, which can be signalled to the consumer tasks and the producer task, are described in claims 6 to 9.

The invention will now be described in more detail with reference to the drawings in which

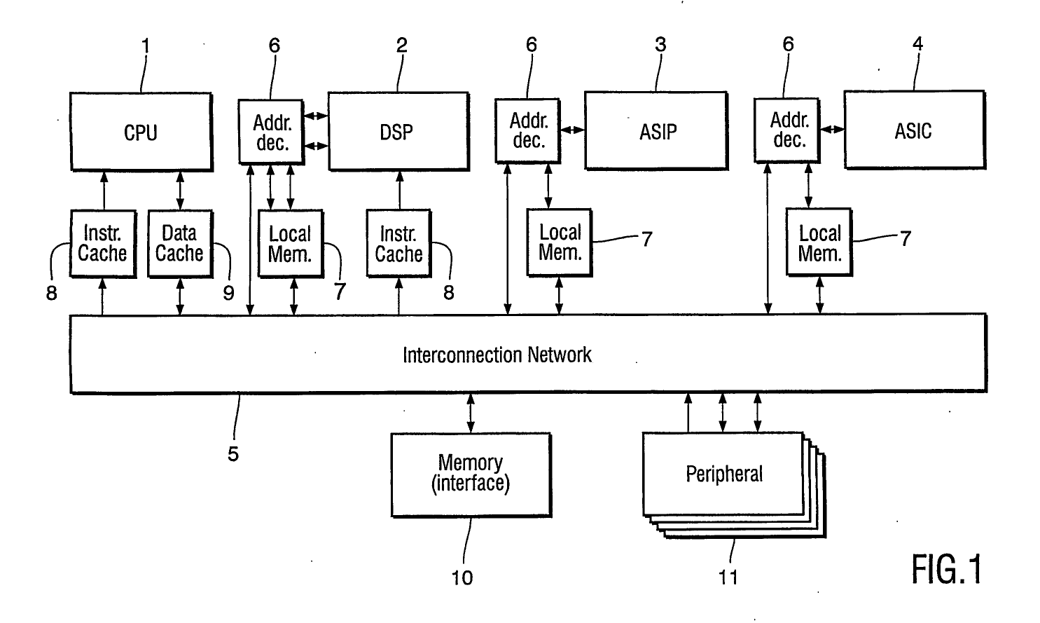

FIG. 1 shows a heterogeneous multi-processor architecture template,

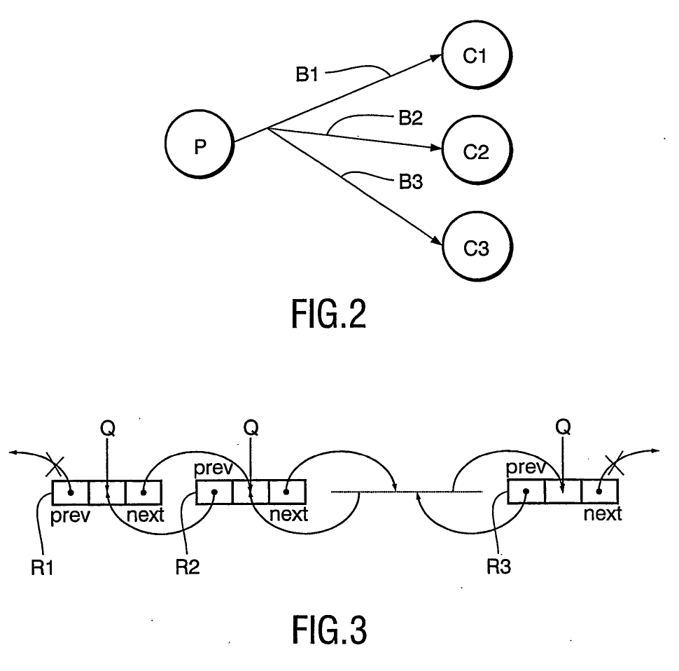

FIG. 2 shows a schematic diagram of the primary and secondary branches,

FIG. 3 shows a schematic diagram of the double linked list of branches and

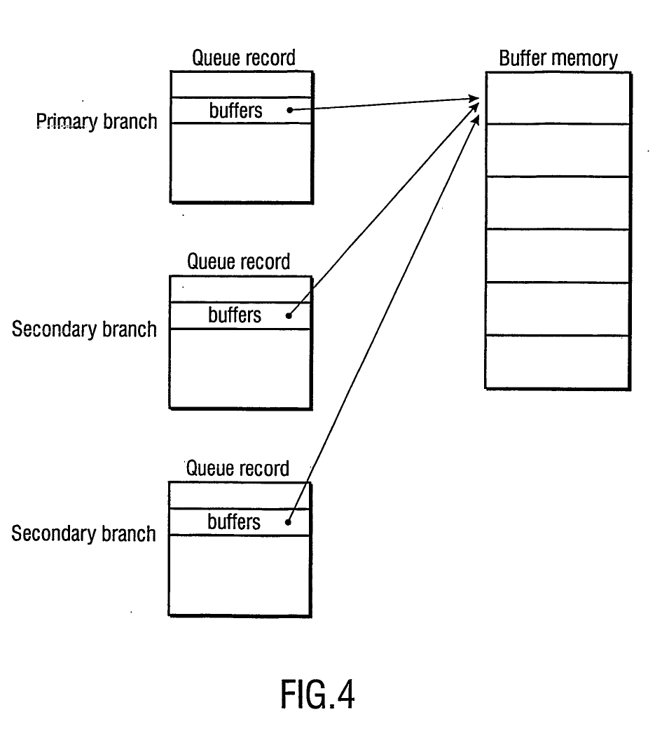

FIG. 4 shows a schematic diagram of several branch records illustrating buffer sharing.

FIG. 1 shows a heterogeneous multi-processor architecture template as one example of a processing apparatus in which the present invention can be preferably applied. Therein, as processing devices a CPU (Central Processing Unit) 1, a DSP (Digital Signal Processor) 2, an ASIP (Application-Specific Instruction-Set Processor) 3 and an ASIC (Application-Specific Integrated Circuit) 4 are shown which are connected by an interconnection network 5. For communication with the interconnection network 5 the DSP 2, ASIP 3 and ASIC 4 are provided with address decoders 6. To avoid that a central shared memory is overloaded, several local memories 7 can be added. They are located closer to processors to also decrease access latency and increase performance. To buffer instructions an instruction cache 8 is provided for the CPU 1 and the DSP 2, and the CPU 1 is further provided with a data cache 9 for buffering data. A general memory 10 is further provided that is shared between said processing devices 1, 2, 3, 4. In addition, peripheral devices 11 can also be connected to the interconnection network 5. The queue structure according to the present invention, which will be explained in the following, is stored in memory 10.

FIG. 2 shows a single-writer multiple-reader circular queue as a collection of branches as proposed according to the present invention. In this figure a producer task P is shown which communicates the same data to three consumer tasks C1, C2, C3. The data is not copied three times in the process. The producer P accesses the structure of the primary branch B1, which is the initially created queue for communicating with consumer C1. This is also the structure accessed by C1. The secondary branches B2, B3, connecting to consumers C2 and C3, are created afterwards, and are accessed by these consumers only. In this way, the producer P is unaware of the number of consumers, and the consumers have no knowledge of each other. By having separate queue structures for each consumer assures that each can access the queue as if it is the only reader of the queue. In this way the queue structure and access mechanism can be kept generic regardless of whether it is single- or multi-reader.

FIG. 3 shows a double-linked list of branches according to the present invention. Shown are several branch records, in particular a primary branch record R1 and two secondary branch records R2, R3. Each branch record has a “nextbranch” field next, which is a reference (pointer) to the next secondary branch. Further, each branch record comprises a “prevbranch” field prev, indicating the previous branch in the list. Hence a double linked list of branches is obtained. Still further, each branch record comprises a queue pointer Q indicating the reference to the memory location on which the queue is mapped.

Further readers can now be added to the queue by adding a branch to the primary branch. The linked list is traversed until the tail is reached, then the new branch queue structure is created and appended to the linked list. In this way, a potentially unlimited number of readers can be added.

When removing a certain branch, the list can be updated by looking up the previous branch and replacing the nextbranch field by the successor branch of the removed branch, and looking up the next branch and replacing its prevbranch field by the predecessor branch of the removed branch.

It should be noted that the branch record of which the prevbranch field is empty is the first branch record in the list, i.e. the primary branch, and the one with an empty nextbranch field is the last branch record in the list. If being able to dynamically remove readers from the queue is not needed, the prevbranch field in the queue structure can be omitted to save memory.

For describing a preferred embodiment of the invention, an existing circular buffer implementation, namely C-HEAP, is taken. The queue structure and the synchronization mechanism of C-HEAP buffers are described extensively in O. P. Gangwal, A. K. Nieuwland, P. E. R. Lippens, “A scalable and flexible data synchronization scheme for embedded HW-SW shared-memory systems”, Proceedings of the International Symposium on System Synthesis (ISSS), October 2001, Montreal. In this context, the queues are referred to as “channels”, however, for the sake of consistency, the term “queues” shall be used in the following. For the preferred embodiment, the application programmer's interface (API) is taken into account for using the proposed queue structure. The C-HEAP queue record currently contains the following information:

Queue-identifier.

Number of buffers in the queue.

Flags indicating the mode in which the queue is operating (interrupt or poll, static or dynamic).

Pointers to the producer and the consumer task records.

The queue buffer pointer.

Two queue synchronization values (pcom and ccom, one on the producer and one on the consumer side). These values are used to determine queue full/emptiness.

Synchronizing data communication on the (single-writer single-reader) queue consists of the use of the following four primitives:
claim_space (queue): claims an empty buffer in the queue for writing
release_data (queue): releases a full buffer and signals the consumer
claim_data (queue): claims a full buffer in the queue for reading
release_space (queue): releases an empty buffer and signals the producer.

A single-writer multiple-reader queue is defined as a collection of queues, each with their own queue record, which have the same producer task and properties (e.g. queue identifier, buffer capacity). The physical buffer memory space is shared between these queues. Consequently, there is no need for copying of data and both memory space and bandwidth requirements are reduced. An alternative is to define a single generic queue record with multi-reader support. The reference to this queue record would then be used by the producer and all the consumer tasks. Such a queue record would then contain one copy of pcom and multiple instantiations of ccom indicating different consumers. Since the rest of the queue information is shared, this results in a lower memory usage than the first option, where the queue records are duplicated. However, it must be possible to distinguish between the different consumers that are accessing the same queue record. This means that some extra information must be passed in the claim_data and release_space function calls (e.g. the task identifier) to identify the particular consumer task. Since these synchronization primitives only use one single argument (i.e. the reference to the queue structure), this would imply changing the API. Since it is not desired that the tasks notice any difference between a single-writer single-reader queue and a single-writer multiple-reader queue, this option is not preferred. Furthermore, in the first option, each consumer of a particular single-writer multiple-reader queue has its own private view of the queue and hence treats it just like a normal single-writer single-reader queue. Therefore, the implementation of claim_data and release_space can remain unchanged.

The following terminology is used (see also FIG. 2):

The primary branch of a multi-reader queue is created in the usual way, by specifying a producer and the first consumer task that communicate through this queue. The queue record created in this step is the only one visible to the producer.

The secondary branches of the single-writer multiple-reader queue are added to the primary branch, connecting an additional consumer to the producer task. This step is transparent to the producer and the other consumers and can even be done during run-time. A new branchrecord is created with the same properties (e.g. number of buffers, mode flags) as the primary branch.

The reason why the branches are not created all at once is due to the ease of programmability. An API function could be defined that accepts multiple consumer tasks as arguments and returns a number of queue record pointers to the individual branches. However, since the number of branches is not fixed and may be unbounded, such a function would be hard to use. The creation of the primary and secondary branches is discussed later.

In order to be able to distinguish between the different branches, and for the tasks to be able to handle them, the original queue record should be extended. A nextbranch field is added in the queue record with the indirection to the next (secondary) branch in the chain. In addition, a prevbranch field is included indicating the previous branch. This is done to support dynamic queue reconfiguration and will also be explained below. If dynamic reconfiguration is not needed, then this field can be omitted to save memory. In this way, a double linked list of all the branches of a multi-reader queue is obtained as shown in FIG. 3.

Obviously, the queue whose prevbranch field is empty is the primary branch, and the one with an empty nextbranch field is the last one in the chain. Using this additional information, by traversing the linked list, ccom of all the branches can be accessed and compared to pcom to determine the queue fullness (which is the maximum over all branches), all the consumer tasks can be signaled after buffer space has been filled during release_data, and the pointers to allocated buffer space can be copied over all branches, allowing buffer sharing (see FIG. 4). Furthermore, since each consumer accesses its own copy of the queue record, no shared variables need to be protected by locks or any special protection mechanisms. In any case, this implementation allows for a potentially unlimited number of consumers.

Synchronization primitives will now be explained. Claim_space compares pcom with the values of ccom on all the consumer sides. This is done by linearly traversing the linked list and reading from all the branch records. Only if none of the comparison actions indicates that the queue is full may this primitive return. To reduce the number of checks, claim_space immediately blocks as soon as a full branch is encountered. If it is blocked and later receives a signal indicating that space has been freed on this full branch, then it continues with the next branch in the list. The earlier comparisons do not have to be repeated, since although the previous branches might have been changed in the mean time, they could not have become full because the producer was blocked. In polling mode, the ccom of the full branch is repeatedly read. The difference in behavior between the multiple-reader case and the single-reader case is the number of compare actions done, since in the single-reader case there is only one element in the list.

When the producer task has filled a memory buffer and updates pcom during release_data, the copies of pcom in the secondary branch records should be updated. Also, all consumer tasks are signaled instead of just one. An optimization is possible here by changing the pcom field in the queue record into a reference (pointer) to some other memory location where pcom is actually stored. In this way, there is only one single copy of pcom visible to all the branches and there is no need to update all the copies of pcom in each branch structure.

On a claim_data, the consumer task compares pcom with the ccom in its own branch record to determine the queue fullness. The situation may occur that the value of pcom it reads is slightly outdated because the update of this value for this branch has not been done yet. Since the consequence is that this consumer might only see fewer filled buffers than there actually are, claim_data will not accidentally return an empty buffer. The behavior of this primitive is exactly the same for both single-reader and multiple-reader queues.

During a release_space, each consumer updates ccom in its own branch and signals the producer of this action. The consequence is that the number of signals sent to the producer is increased. The behavior of this primitive is also the same for single-reader and multiple-reader queues.

As described above, a multi-reader queue consists of a primary and one or more secondary branches. Creating a primary branch is done by using the queue_create function:
queueT* queue_create(int id, taskT* P, taskT* C, int nbuf, int flags);

With this function, a queue is created between producer P and first consumer C, with identifier id, number of buffers nbuf and mode flags flags. This is the only branch visible to the producer. For adding secondary branches to this queue, the following function is used:
queueT* queue_add_branch(queueT* ch, taskT* C);

This function takes the queue record created in the above function (i.e. the primary branch) and copies its contents to a newly created queue record for the secondary branch (except the consumer task field). It then adds the location of this new branch record to the end of the linked branch list and returns a reference to the newly created branch record.

Allocation of queue buffer memory is always performed on the primary branch. Once the buffer locations are known, these are copied to the secondary branches' queue records. This step can be done before adding new branches because the buffer locations are copied from the primary branch anyway. C-HEAP queues can be reconfigured in the following ways:
Destroy
Reroute
Change properties (e.g. buffer size, mode flags)
Add or remove branches

It is probably not desired to destroy all the branches of a single-writer multiple-reader queue at once, therefore separate destruction of the individual branches is supported. The following function is used for this purpose:
void queue_destroy(queueT* queue);

This function takes as argument the pointer to the memory location of the branch record. It should be noted that this is exactly the same function as used to destroy a single-writer single-reader queue. Again this demonstrates the transparency of our approach to the number of readers. Destroying a secondary branch of a single-writer multiple-reader queue is straightforward. Its entry is first removed from the consumer task record. When the branch is removed, the linked list as shown in FIG. 3 is broken, therefore, the list references must be repaired. When a list item is removed, the nextbranch field of its predecessor must be replaced by a pointer to its successor. This is the reason why the prevbranch field has been added in the queue record, because from the to be destroyed branch it must be possible to access its predecessor branch. Likewise, the prevbranch field of its successor must be replaced by a pointer to its predecessor. After this, the record of the destroyed branch is removed from memory.

Removing a branch requires also the producer to be halted first (either stopped or suspended). This is because otherwise the signaling mechanism may be disturbed when the linked list is being updated. For instance, the record of the destroyed branch may have been freed just before being referenced from its predecessor. Since the value read and interpreted as the next branch in the list (which is no longer existent) is no longer defined, this may have fatal consequences. Destroying a primary branch is tricky, since this is the only branch seen by the producer. If the primary branch is removed, then one of the secondary branches must be ‘promoted’ to primary branch. This operation is very simple and implies only that the prevbranch field of the second branch in the list is set to the NULL pointer. Furthermore, the pointer to this newly appointed primary branch must be communicated to the producer task. This can be done by updating the producer's task record and having the task fetch the new queue record pointer after being reactivated. Destroying the queue also includes freeing the buffer memory. Obviously this is only done when the last branch is destroyed.

Dynamically adding branches to an existing queue is possible by calling the queue_add_branch function at run-time. Since the record of this new branch is copied from the primary branch, its initial state (i.e. fullness) will be the same as that of the primary branch. The other branches may have a completely different fullness at that time. It may be desirable that all branches are in the same state when a new branch is added. In this case the consumers have to drain the branches first.

Rerouting a single-writer multiple-reader queue can be done as follows. When this operation is performed on a secondary branch, then only the consumer task is allowed to be changed. In this case, the modifications only concern the record of this particular branch. Changing the producer of the queue is only allowed for the primary branch. To do this, the records of the primary and all secondary branches must be modified by walking through the linked list of branches.

Changing the queue's properties has effect on all the branches, and changing the properties of an individual branch is not allowed. Therefore, this operation is always performed on the primary branch.

The present invention provides a data processing apparatus and a method of synchronizing at least two processing means in such a data processing apparatus which allow multiple readers to share the same queue. No locks or special instructions are needed to simultaneously access the queue administration information by multiple readers. No data is copied during the writing process. Furthermore, the present invention allows the application to dynamically reconfigure the single-writer multiple-reader queue, for instance to add or remove readers at run-time.

1. A data processing apparatus comprising
at least one processing means being capable of providing data for further processing by the same or other processing means,
a queue structure comprising at least two branches between a producer task performed by a first processing means and a number of consumer tasks executed by at least a second processing means,
a memory means for storing data to be accessed by said consumer tasks, said memory means being shared between said at least two branches,
a branch record means comprising a primary branch record for a primary branch between said producer task and a first consumer task and secondary branch records for secondary branches between said producer task and further consumer tasks, said branch records storing a pointer to the same location of said memory means and a reference to the next branch so as to obtain a linked list of branch records.

2. A data processing apparatus as claimed in claim 1,
wherein said secondary branch records further store a reference to the previous branch so as to obtain a double-linked list of branch records.

3. A data processing apparatus as claimed in claim 1,
wherein each said branch record comprises a writer pointer denoting the producer task's position in the queue and a reader pointer denoting the consumer task's position in the queue, said writer pointer being identical for all branch records.

4. A data processing apparatus as claimed in claim 1,
wherein each said branch record comprises a writer counter denoting the producer task's position in the queue and a reader counter denoting the consumer task's position in the queue, said writer counter being identical for all branch records.

5. A method of synchronizing at least two processing means in a data processing apparatus, at least one of which being capable of providing data for further processing by other processing means, said method comprising the steps of:
defining a queue structure comprising at least two branches between a producer task performed by a first processing means and consumer tasks executed by at least a second processing means,
sharing a memory means for storing data to be accessed by said consumer tasks between said at least two branches,
defining a branch record means comprising a primary branch record for a primary branch between said producer task and a first consumer task and secondary branch records for secondary branches between said producer task and further consumer tasks, said branch records storing a pointer to the same location of said memory means and a reference to the next branch so as to obtain a linked list of branch records.

6. A method as claimed in claim 5, further comprising the steps of:
reading a writer pointer or writer counter from said primary branch record,
reading reader pointers or reader counters from said secondary branch records in the linked list,
comparing said reader pointers or reader counters with said writer pointer or writer counter to determine the amount of free buffer space in the individual branches available for writing by the producer task, incrementing said writer pointer or writer counter in the primary queue record after writing a new data item in the queue by the producer task,
updating the value of the writer pointer or writer counter in the secondary branch records, and
signaling to the consumer tasks attached to the queue the change in the queue fullness and unblocking them in case they are in a blocked state.

7. A method as claimed in claim 6,
wherein the actual amount of empty buffer space available in the entire queue is indicated by the minimum amount of empty buffer space over all the branches and wherein the producer task is blocked when any of the branches is full.

8. A method as claimed in claim 5, further comprising the steps of:
reading a writer pointer or writer counter and a reader pointer or reader counter from the associated branch record to determine the number of available data items in the queue available for reading in a particular branch by the associated consumer task.
incrementing said reader pointer or reader counter in the associated branch record after reading a data item from the queue by a particular consumer task, and
signaling to the producer task a change in the queue fullness, thereby unblocking the producer task in case it is in a blocked state.

9. A method as claimed in claim 8,
wherein the consumer task is blocked when its associated branch is empty.

10. A method as claimed in claim 5,
wherein a secondary branch is dynamically added to said queue structure by copying the primary branch's branch record into the new secondary branch's branch record and by adding a reference to the new secondary branch to the previously last branch's branch record.

11. A method as claimed in claim 5,
wherein a secondary branch is removed from said queue structure by removing its secondary branch record from said queue record means and by updating the reference to the next branch stored in its predecessor branch's branch record so as to refer to the removed branch's successor branch and by updating the reference to the previous branch stored in its successor branch's branch record so as to refer to the removed branch's predecessor branch.

12. A method as claimed in claim 5,
wherein the primary branch is removed from said queue structure by removing its primary branch record from said queue record means and by deleting a reference to the primary branch record stored in the first secondary branch's branch record and by informing the producer task of the deletion of the primary branch and the fact that the first secondary branch has now become the primary branch.
